(19) United States
(12) Patent Application Publication
(10) Pub. No.: US 2026/0233239 A1
(43) Pub. Date: Aug. 13, 2026

(54) DRIVE TURBINE FOR A ROTARY ATOMIZER

(71) Applicant: Dürr Systems AG, Bietigheim-Bissingen (DE)

(72) Inventors: Michael Baumann, Flein (DE); Frank Herre, Oberriexingen (DE); Thomas Buck, Sachsenheim (DE); Bernhard Seiz, Lauffen (DE); Harry Krumma, Bönnigheim (DE); Tobias Kleinhans, Benningen (DE); Arved Hess, Konstanz (DE); Stefan Sigrist, Madiswil (CH)

(21) Appl. No.: 19/127,209

(22) PCT Filed: Dec. 1, 2023
(86) PCT No.: PCT/EP2023/083996

§ 371 Date: May 5, 2025

(30) Foreign Application Priority Data
Dec. 16, 2022 (DE) 10 2022 133 678.6

(51) Int. Cl. B05B 3/04

(52) U.S. Cl. CPC B05B 3/0417

(57) ABSTRACT

A drive turbine for a rotary atomizer, having a turbine rotor with a rotatably mounted turbine shaft. The turbine shaft is stepped along its axis of rotation with different shaft diameters, including different inner diameters and/or different outer diameters.

### CROSS-REFERENCE TO RELATED APPLICATIONS

This application is a national stage of, and claims priority to, Patent Cooperation Treaty Application No. PCT/EP2023/083996, filed on Dec. 1, 2023, which application claims priority to German Application No. DE 10 2022 133 678.6, filed on Dec. 16, 2022, which applications are hereby incorporated herein by reference in their entireties.

### TECHNICAL FIELD

The disclosure relates to a drive turbine for a rotary atomizer, in particular for painting motor vehicle body components in a painting installation. The disclosure also relates to a rotary atomizer with such a drive turbine according to the disclosure.

### BACKGROUND

In modern painting installations for painting vehicle body components, rotary atomizers are usually used as application devices, which are driven by a drive turbine with compressed air. The drive turbine has a turbine shaft with a bell cup mounted at the distal end of the turbine shaft, for example by a screw connection between the turbine shaft and the bell cup. During painting operation, the turbine shaft rotates at high speed with the bell cup mounted on it, whereby the bell cup spins and atomizes the paint to be applied from an annular spray edge. The paint is usually fed to the bell cup through a paint tube, which is arranged inside the hollow turbine shaft and contains one or two main needle valves to switch the paint application on or off as required.

With these known rotary atomizers, there is a design conflict regarding the diameter of the turbine shaft.

On the one hand, the largest possible inner diameter of the hollow turbine shaft is desired so that there is sufficient space inside the turbine shaft to accommodate a paint tube with several main needle valves.

On the other hand, a large diameter of the turbine shaft leads to a correspondingly large moment of inertia, which requires a correspondingly large drive power. Furthermore, a large diameter of the turbine shaft also leads to a correspondingly large centrifugal force load and a correspondingly large centrifugal force-induced increase in the speed of the turbine shaft, which is undesirable.

With regard to the technical background of the disclosure, reference should also be made to WO 2015/029 763 A1, US 2005/0 001 057 A1, EP 0 645 191 B1, EP 1 245 290 B1 and DE 10 2010 013 551 A1.

### BRIEF DESCRIPTION OF THE DRAWINGS

FIG. 1 shows an external view of a rotary atomizer according to the disclosed technology.

FIG. 2 shows a sectional view of the drive turbine of the rotary atomizer from FIG. 1.

FIG. 3 shows another sectional view of the drive turbine from FIG. 2.

FIG. 4A shows a perspective view of the wheel of the drive turbine with several turbine blades.

FIG. 4B shows another perspective view of the wheel from FIG. 4A.

FIG. 4C shows a side view of the wheel from FIGS. 4A and 4B.

FIG. 5 shows an enlargement of FIG. 2 to illustrate the flow paths of the turbine exhaust air.

FIG. 6 shows a sectional view of the drive turbine with several brake air nozzles shown schematically.

FIG. 7 shows a sectional view with a discharge device for electrostatic potential discharge.

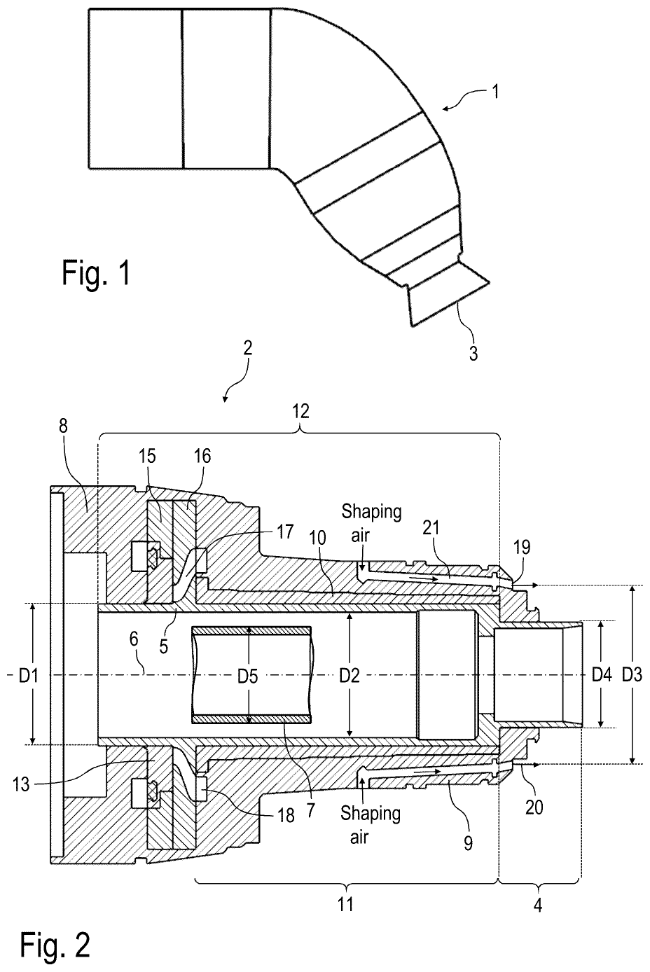

### DETAILED DESCRIPTION OF THE DRAWINGS

The drive turbine according to the disclosed technology is designed to drive a rotary atomizer. It should be mentioned here that the drive turbine according to the disclosure has a turbine rotor with a rotatably mounted turbine shaft. The disclosed technology solves the design conflict of objectives described at the beginning by the turbine shaft by being stepped along its axis of rotation with different shaft diameters, in particular with different inner diameters and/or different external diameters. In the drive turbine according to the disclosure, the diameter of the turbine shaft is therefore not constant along its axis of rotation. This statement regarding the different diameters of the turbine shaft refers to the areas of the turbine shaft axially in front of and axially behind the wheel of the turbine rotor, since the wheel naturally has a larger outer diameter than the rest of the turbine shaft. The turbine shaft according to the disclosure therefore also has different diameters, if one disregards the wheel.

In one embodiment, the turbine shaft has a proximal shaft section with a larger shaft diameter and a distal shaft section with a smaller shaft diameter. Within the scope of the disclosure, this can apply to the inner diameter of the turbine shaft and/or to the outer diameter of the turbine shaft. The large shaft diameter in the proximal shaft section then makes it possible to accommodate a paint tube with several (e.g. three or four) main needle valves, although in the context of the disclosure it is of course also possible for only a single main needle valve to be arranged in the paint tube. The smaller shaft diameter in the distal shaft section, on the other hand, ensures that the moment of inertia and the demands on the drive power are not too great. In this way, the drive turbine according to the disclosure solves the conflict of objectives mentioned at the beginning.

In an embodiment, the turbine shaft has a predetermined outer diameter in the proximal shaft portion, wherein the turbine shaft in the proximal shaft portion carries at least one wheel having a plurality of turbine blades and/or includes a paint tube having a predetermined paint tube outer diameter.

The turbine shaft for receiving the paint tube is hollow and has a specific inner diameter in the proximal shaft section, the inner diameter of the turbine shaft in the proximal shaft section being in the range from 25 mm to 35 mm, a range from 28 mm to 32 mm having proved to be particularly advantageous. In an embodiment of the disclosure, the inner diameter of the turbine shaft in the proximal shaft section is 30.5 mm, whereby a deviation of ±0.5 mm is possible.

Furthermore, it should be mentioned that the drive turbine in some embodiments has at least one annular shaping air nozzle ring with several shaping air nozzles, whereby the individual shaping air nozzles can emit jets of shaping air in order to shape the spray jet of paint applied by the bell cup. This technique of shaping the spray jet of paint by blowing shaping air onto the back of the spray jet is known from the state of the art and is part of general technical knowledge, so no separate description is required in this respect. However, it should be mentioned here that the shaping air nozzle ring has a specific diameter.

It should also be mentioned that the turbine shaft has a certain outer diameter in the distal shaft section and has a mounting interface for mounting a bell cup on the turbine shaft. For example, the bell cup can be mounted on the turbine shaft by a screw connection, but other types of mounting can also be realized within the scope of the disclosure.

In an embodiment of the disclosure, the drive turbine is characterized by certain diameter ratios of the turbine shaft, which are described below.

Thus, the outer diameter of the turbine shaft in the proximal shaft section is larger than the outer diameter of the turbine shaft in the distal shaft section. This advantageously enables the combination of a maximum installation space in the proximal shaft section within the hollow turbine shaft on the one hand and a minimum mass moment of inertia of the turbine shaft on the other.

Here, there is a certain ratio between the outer diameter of the turbine shaft in the proximal shaft section on the one hand and the outer diameter of the turbine shaft in the distal shaft section on the other, which can be in the range of 1.1:1 to 1.6:1, for example, whereby a range of 1.3:1 to 1.4:1 has proven to be particularly advantageous for this ratio.

It should also be mentioned that the inner diameter of the turbine shaft in the proximal section is larger than the outer diameter of the turbine shaft in the distal shaft section. This also enables the combination of a maximum installation space in the proximal shaft section within the hollow turbine shaft on the one hand and a minimum mass moment of inertia of the turbine shaft on the other.

Here, there is a certain ratio between the inner diameter of the turbine shaft in the proximal shaft section on the one hand and the outer diameter of the turbine shaft in the distal shaft section on the other, which can be in the range of 1.05:1 to 1.4:1, whereby a ratio in the range of 1.1:1 to 1.2:1 has proven to be particularly advantageous.

It should also be noted that the diameter of the shaping air nozzle ring is larger than the outer diameter of the turbine shaft in the distal shaft section.

Here, there is a certain ratio between the diameter of the shaping air nozzle ring on the one hand and the outer diameter of the turbine shaft in the distal shaft section on the other hand, which can be in the range from 1.1:1 to 1.9:1, whereby a value for the ratio in the range from 1.3:1 to 1.7:1 has proven to be particularly advantageous in order to discharge the shaping air at the smallest possible radial distance from the axis of rotation of the turbine shaft for optimum consumption of the shaping air. If the shaping air is discharged at a large radial distance from the axis of rotation of the turbine shaft, correspondingly more shaping air should be discharged, so that the shaping air nozzles should be located as close as possible to the axis of rotation.

In an embodiment of the disclosure, the drive turbine has a radial bearing which is located in the proximal shaft section of the shaft turbine and which extends in the axial direction over a certain bearing section. The bearing section is therefore located completely within the proximal shaft section with the larger shaft diameter. For example, this radial bearing can be designed as an air bearing (aerostatic or aerodynamic bearing). In this case, there is a certain ratio between the outer diameter of the turbine shaft in the bearing section on the one hand and the inner diameter of the turbine shaft in the bearing section on the other, in order to achieve a low moment of inertia of the turbine shaft. In an embodiment, this ratio is a maximum of 1.3:1, 1.2:1 or 1.15:1.

It has already been mentioned above that the turbine shaft is hollow and can accommodate a paint tube on the inside, which has a specific outer diameter of the paint tube. There is a certain ratio between the inner diameter of the turbine shaft in the proximal shaft section on the one hand and the outer diameter of the paint tube on the other, this ratio being in the range from 1.005:1 to 1.5:1, a value in the range from 1.01:1 to 1.3:1 having proved to be advantageous in order to achieve a suitable pressure gradient.

In addition, the drive turbine also has an axial bearing with a rotating bearing disk for mounting the turbine shaft, whereby the axial bearing can also be designed as an air bearing (aerostatic or aerodynamic bearing), for example. In addition, the drive turbine according to the disclosure has a speed sensor with a rotating sensor disk for speed detection, as is known from WO 2022/157098 A1. Furthermore, the drive turbine has a wheel with several turbine blades in order to accelerate or decelerate the turbine rotor. Within the scope of the disclosure, it is possible for the bearing disk, the sensor disk and the wheel to be integrated in one component. This integration of several functions (bearing disk, sensor disk and wheel) in one component makes it possible to reduce the complexity of the drive turbine.

It has already been mentioned above that the axial bearing and the radial bearing can be designed as air bearings which emit axial bearing exhaust air and radial bearing exhaust air during operation. It should also be mentioned that the drive turbine is driven by drive air during operation and emits turbine exhaust air.

In the drive turbine according to the disclosure, it is provided that the radial bearing exhaust air in the drive turbine is at least partially combined with the turbine exhaust air in order to increase the temperature of the turbine exhaust air and thereby avoid condensation. For example, the radial bearing exhaust air can be combined with the turbine exhaust air with a proportion of 35%-75% of the radial bearing exhaust air.

In addition, the axial bearing exhaust air in the drive turbine can be at least partially combined with the turbine exhaust air in order to increase the temperature of the turbine exhaust air and thereby avoid condensation in the drive turbine. For example, the axial bearing exhaust air can be combined with the turbine exhaust air with a proportion of 25%-65% of the axial bearing exhaust air.

It has already been briefly mentioned above that the turbine rotor has a wheel with several turbine blades, whereby the turbine blades are blown with drive air by at least one drive air nozzle during operation in order to drive the drive turbine. In addition, several brake air nozzles are provided to blow air against the direction of rotation of the drive turbine blades in order to be able to brake the turbine rotor. The brake air nozzles are distributed around the circumference of the wheel. It should be noted here that the individual brake air nozzles can each flow onto at least two or at least three of the turbine blades at different flow angles. The turbine blades are all of the same design, i.e. no separate, differently shaped turbine blade is provided for braking the drive turbine.

When painting vehicle body components, electrostatic paint charging is usually carried out in order to increase the application efficiency and minimize the disturbing overspray. In the context of such electrostatic paint charging, it can be provided in the context of the disclosure that the drive turbine has a discharge device for discharging electrical potential from the turbine shaft. The discharge device forms a discharge path to ground, with the discharge path having a resistance of less than 10 kΩ.

The discharge path contacts the turbine shaft at its distal shaft section, in particular at an axial distance of less than 5 cm, 3 cm, 2 cm or 1 cm from the distal end of the turbine shaft. This electrical contacting of the turbine shaft at its distal end is advantageous because in this way the discharge path only runs over a small part of the turbine rotor and is therefore relatively short.

In an embodiment of the disclosure, the discharge device surrounds the turbine shaft in an annular shape in the axial direction between the radial bearing and the distal end of the turbine shaft. In this case, the discharge device can also form a seal which seals the radial bearing from the environment. For example, the discharge device can have a brush or a foil for electrical contacting of the turbine shaft.

It has already been mentioned above that the turbine shaft is rotatably mounted in at least one radial bearing, with the radial bearing extending in the axial direction over a specific bearing section that lies within the proximal shaft section of the turbine shaft. The radial bearing has a specific bearing gap in the radial direction. It is advantageous here if the ratio between the axial length of the bearing section on the one hand and the radial bearing gap of the radial bearing on the other hand is in the range from 1000:1 to 8000:1, whereby a value in the range from 2000:1 to 6000:1 has proven to be particularly advantageous in order to achieve sufficient stability and a low bearing loss performance of the radial bearing.

Within the scope of the disclosure, several main valves can be accommodated in the hollow turbine shaft in order to control the coating agent delivery of the rotary atomizer. The term “main valve” used in the context of the disclosure implies, in accordance with the meaning of this term in technical terminology, that there is no further valve downstream of the respective main valve. The main valve therefore serves to switch the paint application on or off. The stepped shape of the turbine shaft makes it possible to arrange more than two, three or even more than four main valves within the hollow turbine shaft. For example, a total of four main valves can be arranged in the hollow turbine shaft. It should be mentioned here that the individual main valves are each designed as needle valves, each of which has a displaceable valve needle which, depending on its position, either opens or closes a valve seat and thereby switches the paint delivery on or off.

In an embodiment of the disclosure, the turbine shaft has only two different shaft diameters, namely the larger shaft diameter in the proximal shaft section and the smaller shaft diameter in the distal shaft section.

It should also be mentioned that, in an embodiment of the disclosure, the drive turbine has a turbine housing, wherein the turbine shaft protrudes with its distal shaft section in the axial direction from the turbine housing so that the bell cup can be mounted on the turbine shaft.

For example, the bell cup can be mounted on the distal end of the turbine shaft by a screw connection, as is known from the prior art. However, other types of fastening are also possible within the scope of the disclosure.

It was explained above that the turbine shaft has different diameters. It should be mentioned here that the transition between the different diameters of the turbine shaft occurs abruptly. Alternatively, however, it is also possible for the transition between the different shaft diameters of the turbine shaft to be continuous, i.e. not abrupt.

Furthermore, it should generally be mentioned that the drive turbine can be either an axial turbine or a radial turbine. However, it is also possible within the scope of the disclosure to have a combination of an axial turbine and a radial turbine.

It should also be noted that the disclosure does not only claim protection for the above-described drive turbine according to the disclosure. Rather, the disclosure also claims protection for a complete rotary atomizer with such a drive turbine. Finally, the disclosure also claims protection for a turbine shaft for a drive turbine of a rotary atomizer, wherein the turbine shaft is stepped along its axis of rotation with different shaft diameters, as already described above. The turbine shaft according to the disclosure can therefore also have the features described above for the complete drive turbine as a replacement part or as an individual component.

The following describes the embodiment of a rotary atomizer 1 according to the disclosed technology shown in the drawings, which can be used for painting vehicle body components in a painting installation. It should be mentioned here that the rotary atomizer 1 is usually guided by a multi-axis painting robot, which, however, is not shown for the sake of simplicity.

The rotary atomizer 1 has a drive turbine 2, which rotates a bell cup 3 at high speed during painting operation.

In this case, the bell cup 3 is mounted by a screw connection on a distal shaft section 4 of a rotatably mounted turbine shaft 5. However, it should be mentioned here that the bell cup 3 does not necessarily have to be mounted on the turbine shaft 5 by a screw connection, since other types of fastening (e.g. clamping connection) are also possible within the scope of the disclosure. The turbine shaft 5 with the bell cup 3 mounted on it then rotates about an axis of rotation 6 during painting operation.

The turbine shaft 5 is hollow and offers space in its interior for a paint tube 7, which is only shown schematically here and can contain several main needle valves, as will be described in detail.

The drive turbine 2 also has a rear housing section 8 and a front housing section 9.

In the front housing section 9 there is a radial bearing 10, which is designed as an air bearing and extends in the axial direction over a bearing section 11.

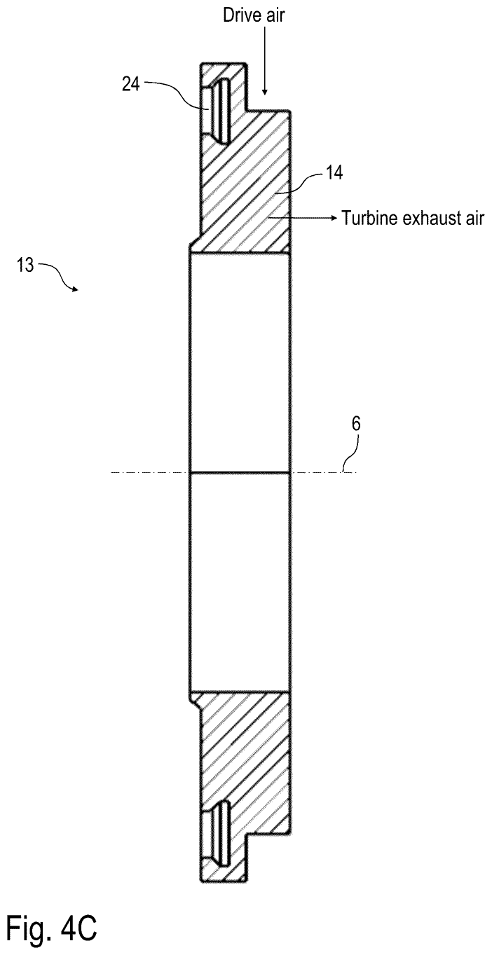

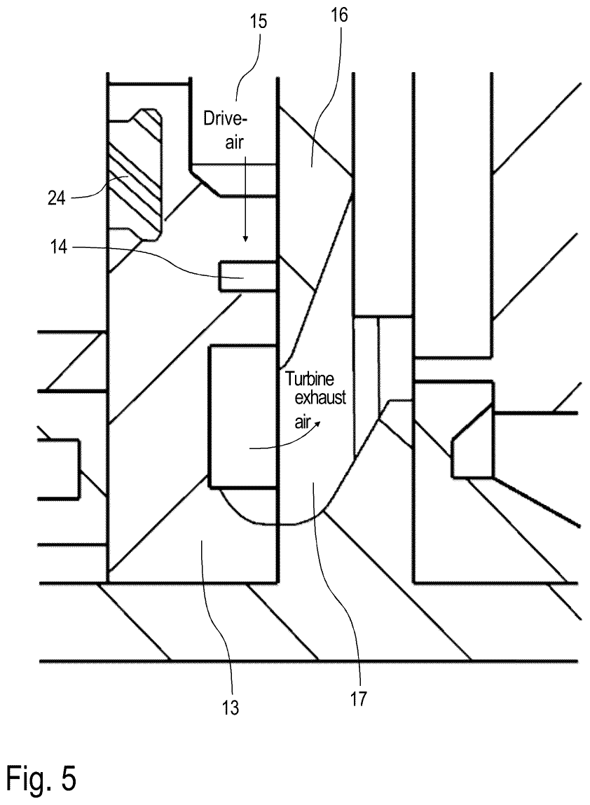

Furthermore, it should be mentioned that the turbine shaft 5 carries a wheel 13 with numerous turbine blades 14 in a proximal bearing section 12, as can be seen in particular from FIGS. 4A-4C, the turbine blades 14 being shown here only schematically.

On its circumference, the wheel 13 is surrounded by a nozzle ring 15, which has a plurality of drive air nozzles distributed around the circumference for blowing on the turbine blades 14 of the wheel 13, as is known from EP 1 388 372 B1, so that the content of this earlier patent is to be attributed in full to the present description with regard to the design of the drive turbine 2.

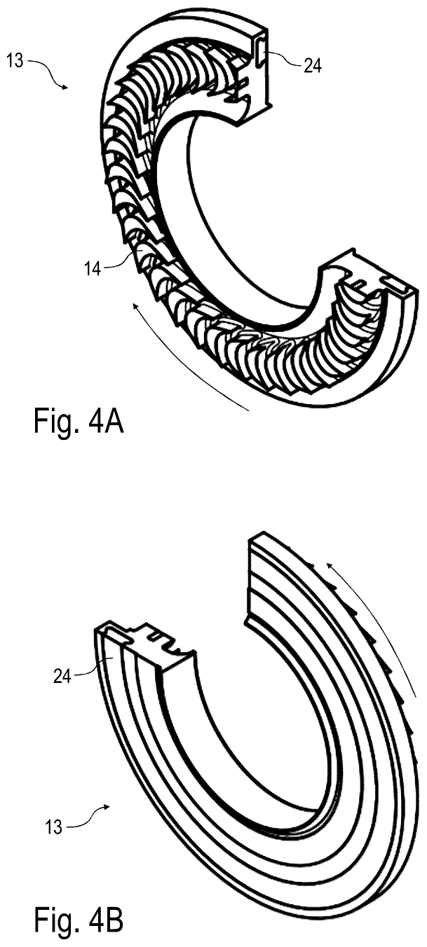

The wheel 13 and the nozzle ring 15 are adjacent to a further stationary ring 16, which contains an exhaust air duct 17 to receive the turbine exhaust air. The exhaust air duct 17 in the stationary ring 16 then finally opens into a common exhaust air duct 18, which also receives radial bearing exhaust air from the radial bearing 10, as can be seen in FIG. 3. This merging of the radial bearing exhaust air with the turbine exhaust air increases the exhaust air temperature at the turbine outlet and thus prevents condensation inside the drive turbine 2.

It should also be mentioned that the wheel 13 is also part of an axial bearing, which also emits axial bearing exhaust air, which is also discharged into the common exhaust air duct 18, as can be seen in FIG. 3. This also increases the exhaust air temperature at the outlet of the turbine, which prevents condensation inside the drive turbine 2.

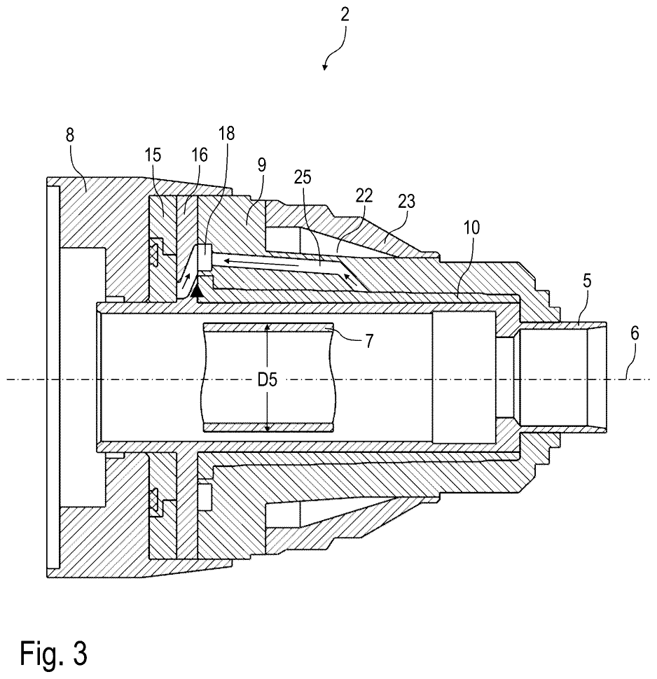

Furthermore, FIG. 2 shows that the drive turbine 2 has a shaping air nozzle ring with numerous shaping air nozzles 19 on its end face, which are distributed around the circumference and each emit a shaping air jet 20. By emitting the jets of shaping air 20, it is possible to shape the spray jet of paint emitted by the bell cup 3.

The shaping air is supplied via a shaping air duct 21, whereby the shaping air duct 21 is fed with shaping air from an air space 22. The air space 22 is located between the front housing section 9 of the drive turbine 2 and an annular housing cover 23. The shaping air supply from the air space 22 is also described in a similar form in EP 1 384 514 B1, so that the content of this earlier patent is fully attributable to the present description.

It should also be mentioned that the wheel 13 of the drive turbine 2 contains a ring-shaped magnetic encoder 24 which enables magnetic speed measurement, as is known from WO 2022/157098 A1, so that the content of this patent publication with regard to the speed measurement is to be attributed to the present description in its entirety.

It should be mentioned here that the wheel 13 fulfills three technical functions. Firstly, the wheel 13 enables a mechanical drive of the turbine shaft 5 by blowing on the turbine blades 14. Secondly, the wheel 13 also enables speed measurement by the ring-shaped magnetic encoder 24. Finally, the wheel 13 also forms part of the axial bearing of the drive turbine 2. This integration of three technical functions in the wheel 13 is advantageous because the number of components required can be reduced as a result.

In this embodiment, the turbine shaft 5 does not have a uniform shaft diameter along the axis of rotation 6. Rather, the outer diameter D1 of the turbine shaft 5 in the proximal shaft section 12 is larger than the outer diameter D4 of the turbine shaft 5 in the distal shaft section 4. The ratio D1:D4 is in the range from 1.3:1 to 1.4:1. This is advantageous for combining the largest possible installation space within the turbine shaft 5 on the one hand with the lowest possible mass moment of inertia of the turbine shaft 5 on the other. The installation space within the hollow turbine shaft 5 is so large that the paint tube 7 can be designed to be correspondingly large so that it can accommodate a total of four main needle valves.

Furthermore, it should be mentioned that the inner diameter D2 of the turbine shaft 5 in the proximal shaft section 12 is also larger than the outer diameter D4 of the turbine shaft 5 in the distal shaft section 4. Thus, the ratio D2: D4 is in the range from 1.1:1 to 1.2:1. This is advantageous for combining the largest possible installation space within the turbine shaft 5 on the one hand with the lowest possible mass moment of inertia of the turbine shaft 5 on the other hand, as already mentioned above.

The diameter D3 of the shaping air nozzle ring with the shaping air nozzles 19 is larger than the outer diameter D4 of the turbine shaft 5 in the distal shaft section 4. The ratio D3: D4 is in the range from 1.7:1 to 1.3:1. This is advantageous for consumption-optimized shaping air delivery at a small distance from the axis of rotation 6 of the turbine shaft 5. When the shaping air is delivered at a large radial distance from the axis of rotation 6 of the turbine shaft 5, correspondingly more shaping air should be delivered, so that the shaping air nozzles 19 should be as close as possible to the axis of rotation 6.

It should also be mentioned that the paint tube 7 in the hollow turbine shaft 5 has a certain outer diameter D5, which is smaller than the inner diameter D2 of the turbine shaft 5. The ratio D2: D5 is in the range of 1.01:1 to 1.3:1 in order to generate a suitable pressure gradient.

FIG. 3 also shows that the radial bearing exhaust air is directed into the common exhaust air duct 18 via an exhaust air duct 25. The exhaust air duct 18 therefore takes in the radial bearing exhaust air, the axial bearing exhaust air and the turbine exhaust air.

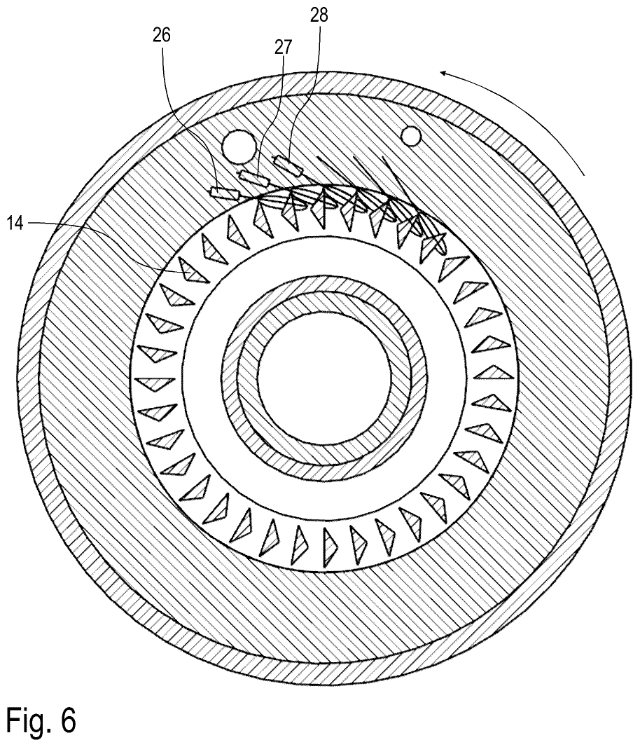

It can also be seen from FIG. 6 that several brake air nozzles 26, 27, 28 are provided, which are only shown schematically here and serve to brake the drive turbine 2 by blowing brake air against the drive direction onto the turbine blades 14. The brake air nozzles 26-28 each blow several of the turbine blades 14 with brake air at different flow angles, which has proven to be advantageous.

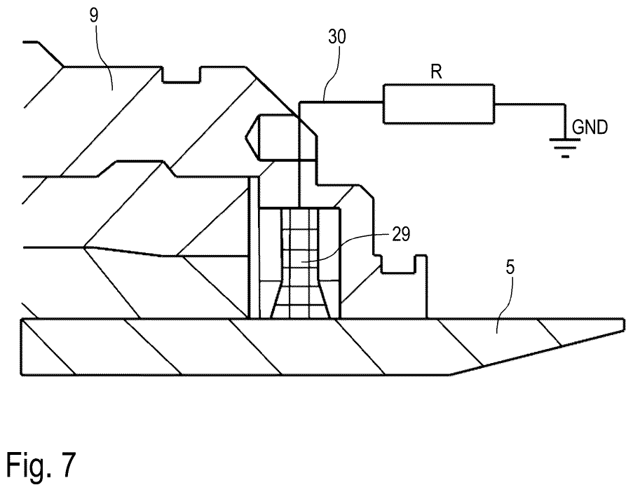

Finally, FIG. 7 shows a discharge device for discharging electrostatic potential from the turbine shaft 5, which is advantageous in the case of electrostatic paint charging.

For this purpose, the discharge device has an annular discharge device 29, which can include a contact brush and rests on the outer surface of the turbine shaft 5 and also forms a seal. The discharge device 29 is connected to ground GND via a discharge path 30, whereby the discharge path 30 has a resistance R<10 kΩ.

### ADVANTAGES OF THE DISCLOSED TECHNOLOGY

The disclosed technology offers the following advantages in particular:
An installation space for four main needle valves is provided in the turbine shaft.
The drive turbine according to the disclosure has a small size.
Weight saving through integration of several functions (bearing disk, sensor disk and turbine wheel) in one component.
Optimized guidance of the bearing air.
Improved braking effect.
Better high voltage discharge.
Improved stability and robustness against imbalances.

The disclosure is not limited to the embodiments described above. Rather, a large number of variants and modifications are possible which also make use of the disclosed technology and therefore fall within the scope of this disclosure. This applies for example to the disclosures relating to the discharge device, the dimensioning of the bearing gap, the brake air flow and the merging of the bearing air discharge with the turbine exhaust air.

1-17. (canceled)

18. A drive turbine for a rotary atomizer, comprising:
a) a turbine rotor with a rotatably mounted turbine shaft,
b) wherein the turbine shaft is stepped along its axis of rotation with different shaft diameters, including different inner diameters and/or different external diameters.

19. The drive turbine according to claim 18, wherein the turbine shaft has a larger shaft diameter in a proximal shaft section than in a distal shaft section.

20. The drive turbine according to claim 18, wherein the turbine shaft larger inner diameter in a proximal shaft section than in a distal shaft section.

21. The drive turbine according to claim 19, wherein
a) the turbine shaft has an outer diameter in the proximal shaft section, wherein the turbine shaft in the proximal shaft section
a1) carries at least one wheel with several turbine blades and
a2) contains a paint tube with a paint tube outer diameter,
b) the turbine shaft for receiving a paint tube of the rotary atomizer is hollow and has an inner diameter in the proximal shaft section, the inner diameter in the proximal shaft section being in the range from 25 mm to 35 mmm,
c) the drive turbine has at least one annular shaping air nozzle ring with a plurality of shaping air nozzles, the shaping air nozzle ring having a diameter, and
d) the turbine shaft has an external diameter in the distal shaft section and has a mounting interface, in order to mount a bell cup on the turbine shaft.

22. The drive turbine according to claim 21, wherein
a) the outer diameter of the turbine shaft in the proximal shaft section is larger than the outer diameter of the turbine shaft in the distal shaft section, in order to combine a maximum installation space in the proximal shaft section with a minimum mass moment of inertia of the turbine shaft, and
b) there is a ratio between the outer diameter of the turbine shaft in the proximal shaft section on the one hand and the outer diameter of the turbine shaft in the distal shaft section on the other hand, which is in the range from 1.1:1 to 1.6:1.

23. The drive turbine according to claim 21, wherein
a) the inside diameter of the turbine shaft in the proximal shaft section is larger than the outer diameter of the turbine shaft in the distal shaft section, in order to combine a maximum installation space in the proximal shaft section with a minimum mass moment of inertia of the turbine shaft, and
b) there is a ratio between the inside diameter of the turbine shaft in the proximal shaft section on the one hand and the outer diameter of the turbine shaft in the distal shaft section on the other hand which is in the range from 1.05:1 to 1.4:1.

24. The drive turbine according to claim 21, wherein
a) the diameter of the shaping air nozzle ring is greater than the outer diameter of the turbine shaft in the distal shaft section, and
b) there is a ratio between the diameter of the shaping air nozzle ring on the one hand and the outer diameter of the turbine shaft in the distal shaft section on the other hand, which is in the range from 1.1:1 to 1.9:1, in order to discharge the shaping air at a small distance from the axis of rotation of the turbine shaft for consumption-optimized shaping air utilization.

25. The drive turbine according to claim 18, further comprising
a) a radial bearing for mounting the turbine shaft in a bearing section within the proximal shaft section,
b) a ratio of at most 1.3:1 between the outer diameter of the turbine shaft in the bearing section on the one hand and the inside diameter of the turbine shaft in the bearing section on the other hand, in order to achieve a low moment of inertia of the turbine shaft.

26. The drive turbine according to claim 18, wherein
a) the turbine shaft is hollow and contains the paint tube with the paint tube outer diameter inside, and
b) there is a ratio between the inner diameter of the turbine shaft in the proximal shaft section on the one hand and the paint tube outer diameter on the other hand, which is in the range from 1.005:1 to 1.5:1 in order to generate a suitable pressure gradient.

27. The drive turbine according to claim 18, wherein
a) the drive turbine has an axial bearing with a rotating bearing disk for mounting the turbine shaft,
b) the drive turbine has a speed sensor with a rotating sensor disk for speed detection,
c) the drive turbine has a wheel with a plurality of turbine blades, and
d) the bearing disk, the sensor disk and the wheel are integrated in one component.

28. The drive turbine according to claim 18, wherein
a) an axial bearing is provided for mounting the turbine shaft, which is designed as an air bearing and emits axial bearing exhaust air during operation,
b) a radial bearing is provided for mounting the turbine shaft, which is designed as an air bearing and emits radial bearing exhaust air during operation,
c) the drive turbine is driven by drive air during operation and emits turbine exhaust air,
d) the radial bearing exhaust air in the drive turbine is at least partially combined with the turbine exhaust air, in order to increase the temperature of the turbine exhaust air and thereby avoid condensation, and
e) the axial bearing exhaust air in the drive turbine is at least partially combined with the turbine exhaust air, in order to increase the temperature of the turbine exhaust air and thereby avoid condensation.

29. The drive turbine according to claim 18, wherein
a) the turbine rotor has at least one wheel with a plurality of turbine blades,
b) the drive turbine has at least one drive air nozzle for blowing on the turbine blades in a drive direction of rotation for driving the turbine rotor,
c) the drive turbine has a plurality of brake air nozzles for blowing on the turbine blades against the direction of drive rotation in order to brake the turbine rotor,
d) the brake air nozzles are distributed around the circumference,
e) the individual brake air nozzles each flow onto at least two or at least three of the turbine blades at different flow angles,
f) the turbine blades are all of the same design without an additional, differently shaped turbine blade for braking the drive turbine.

30. The drive turbine according to claim 18, wherein
a) the drive turbine has a discharge device for discharging electrical potential from the turbine shaft, and
b) the discharge device forms a discharge path to ground, the discharge path having a resistance of less than 10 kΩ, and
c) the discharge path contacts the turbine shaft at its distal shaft section at an axial distance of less than 5 cm from the distal end of the turbine shaft, and
d) the discharge device surrounds the turbine shaft in an annular manner, namely in the axial direction between the radial bearing and the distal end of the turbine shaft, and
e) the discharge device forms a seal which seals the radial bearing from the environment.

31. The drive turbine according to claim 18, wherein
a) the turbine shaft is rotatably mounted in a radial bearing,
b) the radial bearing extends in the axial direction over a certain bearing section which lies within the proximal shaft section,
c) the radial bearing has a specific bearing gap in the radial direction, and
d) the ratio between the axial length of the bearing section on the one hand and the radial bearing gap of the radial bearing on the other hand is in the range from 1000:1 to 8000:1, in order to achieve sufficient stability and a low bearing loss performance of the radial bearing.

32. The drive turbine according to claim 18, wherein
a) the turbine shaft is hollow,
b) the hollow turbine shaft includes a plurality of main valves to control the coating agent dispensing of the rotary atomizer, with no further valve downstream of the main valves.

33. The drive turbine according to claim 32, wherein
a) the number of main valves in the hollow turbine shaft is greater than two, and
b) the main valves are each designed as a needle valve with a displaceable valve needle which, depending on its position, either opens or closes a valve seat.

34. The drive turbine according to claim 18, wherein
a) the turbine shaft has only two different shaft diameters, namely the larger shaft diameter in the proximal shaft section and the smaller shaft diameter in the distal shaft section, and
b) the drive turbine has a turbine housing and the turbine shaft projects with the distal shaft section in the axial distal direction out of the turbine housing, and
c) the turbine shaft has at its distal end a fastening device for fastening a bell cup, in particular a screw thread for screwing the bell cup onto the turbine shaft, in particular as an external thread or as an internal thread, and
d) the transition between the different shaft diameters of the turbine shaft takes place abruptly or continuously, and
e) the drive turbine is an axial turbine or a radial turbine.

35. A rotary atomizer comprising a drive turbine according to claim 18.

36. turbine shaft adapted for a drive turbine of a rotary atomizer, wherein the turbine shaft is stepped along its axis of rotation with different shaft diameters.
